(19) United States
(12) Patent Application Publication
(10) Pub. No.: US 2004/0226176 A1
(43) Pub. Date: Nov. 18, 2004

(54) Razor blades having a non-linear cutting edge and a method for manufacture thereof

(76) Inventor: Dennis J. Peterlin, Stratford, CT (US)

Correspondence Address: Richard R. Michaud, McCormick, Paulding & Huber LLP, Cityplace II, 185 Asylum Street, Hartford, CT, 06103, US

(21) Appl. No.: 10/814,457

(22) Filed: Mar. 31, 2004

Related U.S. Application Data
(60) Provisional application No. 60/460,335, filed on Apr. 3, 2003.

(51) Int. Cl. B26B 19/44

(52) U.S. Cl. 30/346.54; 30/346.56

(57) ABSTRACT

The present invention is directed to a razor blade having a non-linear cutting edge and a method for making the razor blade. The razor blade comprises a substrate and a coating layer applied to at least one surface thereof. The coating layer is etched to define a plurality of substantially co-planar cutting edge patterns collectively forming a non-linear cutting edge on the razor blade. Each cutting edge pattern defines an exterior edge having a sharpness sufficient to cut hair. Preferably, a portion of the substrate is removed so that the exterior edges of the cutting edge patterns are offset from the substrate.

### CROSS-REFERENCE TO RELATED APPLICATION

This application is entitled to the benefit of and incorporates by reference essential subject matter disclosed in Provisional Patent Application No. 60/460,335 filed on Apr. 3, 2003.

### FIELD OF THE INVENTION

The present invention relates generally to razor blades for use in wet shaving razor systems, and more particularly, to razor blades having non-linear cutting edges.

### BACKGROUND OF THE INVENTION

In general, wet shaving systems attempt to simultaneously satisfy three main functional features: comfort, closeness and safety. Over the years, new technologies have been utilized in razor designs to improve these functional features, and, in general, make such razors more efficient at their intended task. Most efforts to improve shaving efficiency have been directed at reducing the cut force between the razor blade and the hair shafts. “Cut force” is the force required to sever a material (e.g., hair) when a razor blade is moved approximately perpendicularly through that material at a constant velocity. Accordingly, much attention has been placed on the cutting edge of the razor blade, and in particular on creation of sharp cutting edges that will reduce the cut force without compromising overall safety of the razor.

For the last 100 years, mass produced razor blades for use with wet shaving systems have been formed by grinding and stropping the cutting edges of the blades, generally in a continuous strip form. This process has proven to be sufficient for controlling the cutting edge dimensions while minimizing the manufacturing costs. However, the process limits the cutting edges of the razor blades to an essentially linear form along the length of the blade. Moreover, though straight-edged blades have gained acceptance in the art, such blades have limited reductions in cut force because of limited effective cutting edge area per unit of length.

The use of non-linear cutting edges, such as serrated or scalloped edges, in razor blades provides blades having greater effective cutting edge per unit of length than conventional straight-edged blades. However, the known processes for creating such blades do not generally lend themselves to the high rates of mass production required for the razor blade industry. That is, non-linear cutting edges are harder to mass produce on continuous strips of blade material than straight-edged blades. Consequently, non-linear blades require more time to create the distinct blade edges.

Even the known methods for creating non-linear cutting edges fail to sufficiently produce blades with the configurations needed to improve the shaving performance of the razor. For example, it is difficult to create large numbers on the order of about 100 to about 2500 per linear inch of small serrations or scallops or other non-linear patterns on cutting edges using the known processing methods. Additionally, it is difficult to grind or sharpen non-linear cutting edges, especially where the cutting edges take the form of small serrations or scallops.

There is a need for a razor blade design that reduces cut force by increasing the cutting edge per unit of length while being mass producible in a manner comparable to the conventional straight-edged razors.

### SUMMARY OF THE INVENTION

The present invention is directed in a first aspect to a method for making a razor blade having a non-linear cutting edge wherein a substrate has a coating layer applied over at least one surface thereof to form a razor blade blank. The coating layer is etched to define a plurality of substantially co-planar cutting edge patterns forming a non-linear cutting edge on the razor blade blank, each of the cutting edge patterns defining an exterior edge having a sharpness sufficient to cut hair. A portion of the substrate is removed so that the exterior edges of the cutting edge patterns are offset from the substrate.

The present invention also resides in a second aspect in a razor blade having a non-linear cutting edge, wherein a plurality of substantially co-planar cutting edge patterns are formed in a coating layer applied to at least one surface of a substrate. Each cutting edge pattern defines an exterior edge having a sharpness sufficient to cut hair, and the exterior edges of the cutting edge patterns collectively form the non-linear cutting edge of the razor blade.

The present invention has an advantage of producing a razor blade having a non-linear cutting edge with dimensions sufficient to improve the shaving performance of the razor system in which the razor blade is incorporated. For example, serrated or scalloped teeth of the blade can have a period preferably within the range of about 10 to about 200 microns from crest to crest, and a depth within the range of about 10 to about 100 microns from crest to trough. Thus, blades manufactured in accordance with the present invention have a greater effective cutting length per unit of blade length than a razor with a straight cutting edge.

The present invention also provides the advantage of producing a non-linear cutting edge where the sharpness of the non-linear cutting edge, as defined in part by the blade tip radius, can vary over the length of the blade, or over the respective surfaces of shaving patterns forming the non-linear cutting edge, without increasing the manufacturing time of the blade. For example, the safety of the razor blade can be improved by blunting the tips of serrations or scallops forming the non-linear cutting edge while increasing the sharpness of the peripheral sides of each serration or scallop to a level sufficient to cut hair with a reduced cut force.

The present invention also eliminates the need for grinding the cutting edge without compromising the sharpness and geometry of the blade, thereby reducing manufacturing time.

The present invention also has the advantages of longer effective blade length and improved safety based on the improved geometry of the design.

### BRIEF DESCRIPTION OF THE DRAWINGS

FIG. 1 is a perspective view of a conventional razor blade assembly in which razor blades produced in accordance with the present invention may be mounted.

FIG. 2 illustrates a serrated blade design produced in accordance with the present invention.

FIG. 3 is a cross-sectional view of the razor blade illustrated in FIG. 2 taken along reference line A-A.

FIG. 4 illustrates an alternate cross-sectional view for the razor blade illustrated in FIG. 2 taken along reference line A-A.

FIG. 5 illustrates a scalloped blade design produced in accordance with the present invention.

FIG. 6 illustrates an alternate blade design having repeating cutting edge patterns produced in accordance with the present invention.

FIG. 7 illustrates an alternate scalloped blade design produced in accordance with the present invention.

### DETAILED DESCRIPTION OF PREFERRED EMBODIMENT

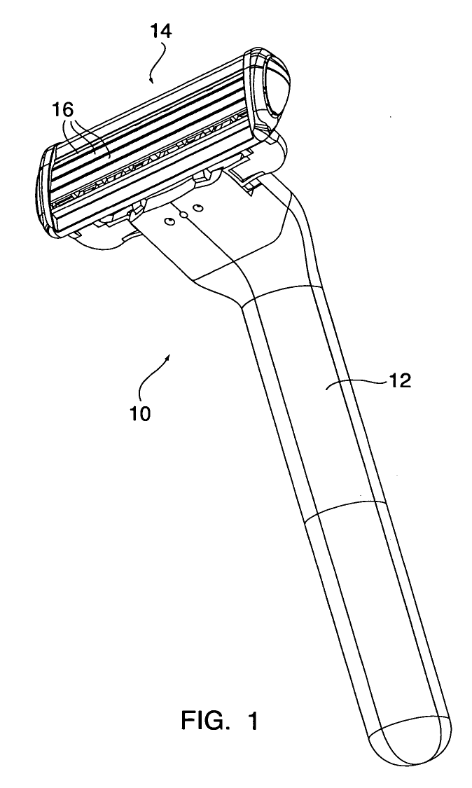

In FIG. 1, a conventional razor assembly 10 is shown, and includes a handle 12 and a razor cartridge 14 coupled to the handle 12 and in which razor blades generally designated by the reference numeral 16 and produced in accordance with the present invention are mounted.

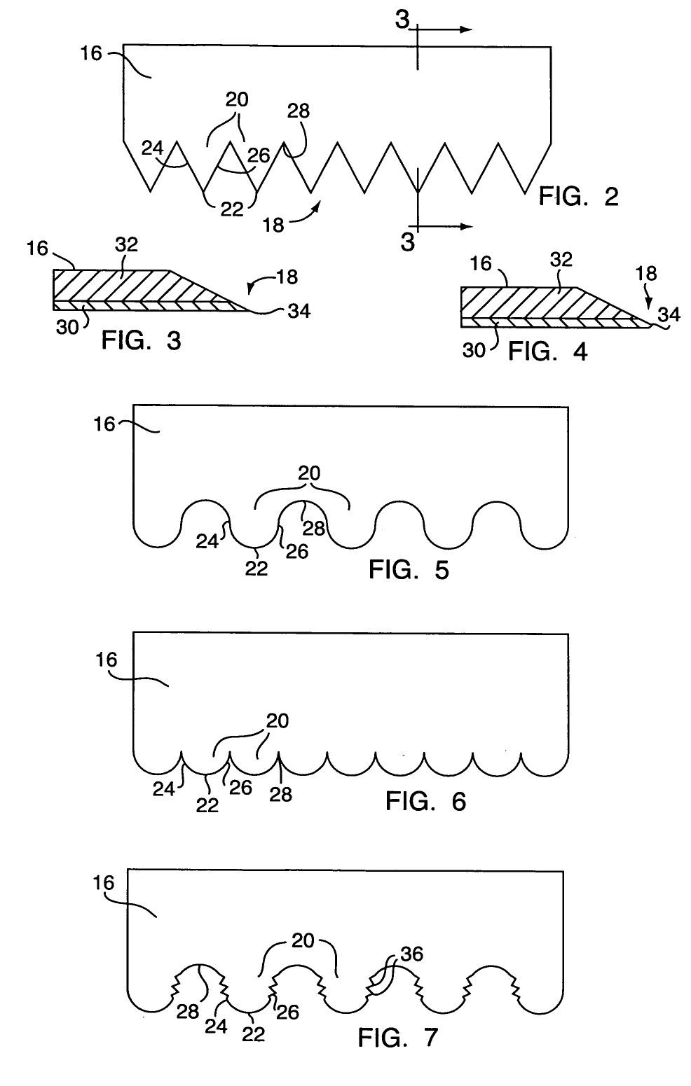

As illustrated in FIGS. 2, 5, 6 and 7, razor blades 16 each have a non-linear cutting edge generally designated by the reference numeral 18. The non-linear cutting edge 18 generally has the form of a continuous series of generally co-planar cutting edge patterns 20, such as serrations, scallops or other shapes, generally referred to hereinafter as “teeth”. The teeth 20 are exaggerated in size and dimension in the Figures for illustration purposes only. Like reference numerals designate corresponding components in the various embodiments illustrated in the Figures.

As shown in FIG. 2, each tooth 20 has a crest or tip 22, a first peripheral side 24 and a second peripheral side 26. Troughs or valleys 28 are located between each tooth 20. The teeth 20 can all have identical size and shape, or may be varied in size and shape, as desired, along the length of the razor blade 16 to optimize shaving efficiency. Additionally, the distance between successive teeth 20, and thus the size and shape of the troughs 28, can be uniform along the length of the blade 16, or may be varied, as desired. Preferably, the teeth 20 are arranged periodically—i.e., having a substantially repeating pattern. As shown in FIG. 2, the teeth 20 are serrated and saw-toothed, and have discrete pointed crests 22 and angled troughs 28. FIG. 5 shows teeth 20 in the form of a continuous series of minute scallops corresponding to a substantially sinusoidal wave. The crests 22 and troughs 28 of the teeth 20 shown in FIG. 5 are more transitory and less discrete than those shown in FIG. 2. Another example of a substantially repeating tooth pattern for razor blades 16 in accordance with the present invention is illustrated in FIG. 6.

The period, amplitude and slope of the teeth 20 can vary depending on the desired shaving performance. For example, more teeth 20 along the length of the blade 16 increases the effective length of the cutting edge 18 per unit of blade length. Similarly, teeth 20 with greater amplitude have longer sides 24, 26 for engaging the hair shafts. Accordingly, the balance between period, amplitude and slope must be coordinated to increase the comfort, closeness, safety and overall effectiveness of the shaving performance. Preferably, the teeth 20 have a period within the range of about 10 to about 200 microns from crest to crest, and an amplitude within the range of about 10 to about 100 microns from crest to trough. Ideally, the period and amplitude are coordinated so as to provide a high effective cutting edge 18 per unit of blade length without compromising the efficiency of the blade 16 under normal shaving conditions.

As shown in FIGS. 3-4, the blade 16 comprises a coating layer 30 from which the cutting edge 18 is created, and a base substrate 32. Prior to creation of the teeth 20 in the blade 16, the coating layer 30 is commonly created or deposited on the base substrate 32, for example by chemical vapor deposition (CVD) or a similar process, to form a razor blade blank. The razor blade blank can be individual strips corresponding to individual razor blades 16, or a continuous strip of material from which a plurality of razor blades 16 can be formed.

The cutting edge 18 is normally formed from the coating layer 30. Thus, the coating layer 30 should have a hardness similar to that typically associated with razor blades. Preferably, the coating layer 30 comprises a hard material such as an amorphous diamond material or other diamond layer. Other potential coating materials include, but are not limited to, ceramic, metal, oxides, nitrides, carbides, silicon dioxide, titanium nitride, chromium nitride and titanium carbonitride. Alternative methods for creating the coating layer 30 include, but are not limited to, physical vapor deposition, evaporation, cathodic arc deposition, plasma-enhanced chemical vapor deposition (PECVD), ion beam deposition, sputtering, plasma spray and magnetron sputtering.

In the illustrated embodiment, the base substrate 32 acts as a carrier layer and preferably provides structural support for the blade 16, especially after the teeth 20 are formed in the coating layer 30. The base substrate 32 preferably is constructed from a metal or silicon-based material. Other suitable materials for the base substrate 32 include, but are not limited to, amorphous metal, ceramic, plastic, amorphous glass and silicon dioxide.

The coating layer 30 preferably extends forward of the base substrate 32, as shown in FIGS. 3-4, so that the cuffing edge 18 is offset from the base substrate 32 and, for example, can engage hair shafts without interference from the base substrate 32. The sharpness of the cuffing edge 18 is created by beveling at least the edge of the coating layer to form a blade tip 34. A portion of the base substrate 32 can be stripped away from the cutting edge 18 during the beveling process (which may be the process used to create the teeth 20 in the coating layer 30). As shown, both the coating layer 30 and the base substrate 32 are beveled. Thus, the sharpness of the cuffing edge 18 is defined by the blade tip angle and radius. Preferably, the blade tip 34 has an angle in the range of about 7 to about 30 degrees. The blade tip angle can be substantially uniform along the length of the blade 16, or can vary, as desired. The blade tip 34 can be single faceted, as shown in FIG. 3—i.e., one side of the cuffing edge 18 is beveled while the other side is straight. Alternatively, the blade tip 34 can be double-faceted, as shown in FIG. 4.

Altering the shape of the teeth 20 changes the feel of the blade 16 against the skin surface. Therefore, the shape of the teeth 20 can vary depending on the desired performance and effectiveness for the blade 16. The feel of the blade 16 can also be adjusted, by altering the angle of the blade tip 34, or by varying the blade tip radius. Traditionally, the entire cuffing edge 18 of the blade 16 should be sharp, for example, having a blade tip radius in the range of about 300 to about 700 angstroms, and more preferably in the range of about 300 to about 500 angstroms.

To create the teeth 20, the coating layer 30 is removed to create the desired shape of the teeth 20. The cross-sectional blade tip 34 is also created to impart sharpness to the tooth 20. For example, the teeth 20 of the blade 16 are preferably created by using a plasma etch or polish to remove the corners around each tooth pattern 20 and expose sharp edges along the cutting edge 18. Portions of the base substrate 32 may also be stripped away during the creation of the tooth patterns 20. Other methods for creating the teeth include, but are not limited to reactive ion etching, chemical etching, electrochemical etching, and chemical/mechanical polishing. The cutting edge 18 may also be formed or sharpened with an additional polishing or grinding process. The desired coating layer 30 can be cured or hard-baked prior to etching so as to make a portion of the coating layer 30 impervious to etching thus defining the cutting edge shape. A mask may also be used to define the desired tooth patterns 20 along the coating layer 30 before etching.

The sharpness of the cutting edge 30 can be varied along the length of the blade 16, or even along the length of each individual tooth 20. For example, the crests 22 of the teeth 20 can be blunted to improve safety of the blade 16. The sharpness can correspondingly vary down the peripheral sides of the teeth such that the sharpest portion of each tooth are on the first and second sides 24, 26.

In an alternative embodiment of the present invention, each tooth 20 has smaller cutting edge patterns, such as micro-teeth 36, disposed along the first and second sides 24, 26. For example, FIG. 7 illustrates scalloped teeth 20 having micro-scallops 36 thereon. The additional micro-teeth 36 increases the cutting edge area that will contact the hair shaft. Preferably, the micro-teeth 36 engage the hair simultaneously. During a shaving operation, the teeth 20 and micro-teeth 36 can engage the hair in a sawing action along length of the blade 16.

In the embodiments shown, the blades 16 are single-edged blades, though the present invention applies to double-edged blades as well. The blades 16 having non-linear cutting edges 18 in accordance with the present invention can be used in any of a number of different razor configurations. During shaving, as the cutting edge 18 is drawn across the user's skin surface, the teeth 20 contact hair protruding from the skin surface and cut and remove the hair.

While the invention had been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A method for making a razor blade having a non-linear cutting edge comprising the steps of:
providing a substrate;
applying a coating layer onto at least one surface of said substrate to form a razor blade blank;
etching the coating layer to define a plurality of substantially co-planar cutting edge patterns collectively forming a non-linear cutting edge on the razor blade blank, each of said cutting edge patterns defining an exterior edge having a sharpness sufficient to cut hair; and
removing a portion of the substrate so that the exterior edges of said cutting edge patterns are offset from the substrate.

2. A method as defined by claim 1, wherein the step of applying a coating layer includes applying at least one of a diamond, ceramic, metal, oxide, nitride, carbide, silicon dioxide, titanium nitride, chromium nitride and titanium carbonitride.

3. A method as defined by claim 1, wherein the step of applying a coating layer of material comprises depositing the coating layer onto said at least one surface of said substrate using chemical vapor deposition.

4. A method as defined by claim 3, wherein the step of depositing the coating layer includes depositing a layer of a diamond material.

5. A method as defined by claim 1, wherein the step of etching the coating layer comprises at least one of plasma etching, reactive ion etching, chemical etching, electrochemical etching and chemical-mechanical polishing.

6. A method as defined by claim 5, wherein the step of etching the coating layer comprises plasma etching.

7. A method as defined by claim 5, further comprising the step of grinding the cutting edge patterns.

8. A method as defined by claim 1, wherein the substrate comprises at least one of silicon, metal, amorphous metal, ceramic, polymeric material, amorphous glass and silicon dioxide.

9. A method as defined by claim 1, wherein the step of etching the coating layer further comprises the step of varying the sharpness along the exterior edge of each cutting edge pattern.

10. A method as defined by claim 9, wherein the sharpness of each cutting edge pattern is defined by a blade tip radius along the exterior edge of each said cutting edge pattern.

11. A method as defined by claim 10, wherein the blade tip radius for each said cutting edge pattern is between about 300 and about 700 angstroms.

12. A razor blade having a non-linear cutting edge, said razor blade comprising:
a substrate;
a coating layer applied to at least one surface of said substrate, said coating layer having a plurality of substantially co-planar cutting edge patterns, each cutting edge pattern defining an exterior edge having a sharpness sufficient to cut hair; and wherein
the exterior edges of the cutting edge patterns collectively form the non-linear cutting edge.

13. The razor blade of claim 12, wherein the cutting edge patterns are substantially offset from the substrate.

14. The razor blade of claim 12, wherein the cutting edge patterns have substantially uniform sizes and shapes.

15. The razor blade of claim 14, wherein said cutting edge patterns are serrations, each defining a crest, a first side, a second side, and, in combination with an adjacent cutting edge pattern, a trough.

16. The razor blade of claim 14, wherein each of said cutting edge patterns is scallop-shaped defining a crest, a first side, a second side, and, in combination with an adjacent cutting edge pattern, a trough.

17. The razor blade of claim 14, said cutting edge patterns ranging on the order of about 100 to about 2,600 per linear inch.

18. The razor blade of claim 14, the periodic distance between adjacent cutting edge patterns ranging between about 10 and about 200 microns.

19. The razor blade of claim 14, the amplitude of each cutting edge pattern ranging between about 10 and about 100 microns.

20. The razor blade of claim 12, wherein the coating layer comprises at least one of a diamond, ceramic, metal, oxide, nitride, carbide, silicon dioxide, titanium nitride, chromium nitride and titanium carbonitride.

21. The razor blade of claim 12, wherein the substrate comprises at least one of silicon, metal, amorphous metal, ceramic, polymeric material, amorphous glass and silicon dioxide.

22. The razor blade of claim 12, wherein the sharpness of each cutting edge pattern is varied along the exterior edge thereof.

23. The razor blade of claim 22, wherein the sharpness of each cutting edge pattern is defined by a blade tip radius of the exterior edge thereof.

24. The razor blade of claim 23, wherein the blade tip radius is in the range of between about 300 and about 700 angstroms.

25. The razor blade of claim 22, wherein the cutting edge patterns have substantially uniform sizes and shapes, each defining a crest, a first side, a second side, and, in combination with an adjacent cutting edge pattern, a trough.

26. The razor blade of claim 25, wherein the respective sharpnesses of the first and second sides of each cutting edge pattern is greater than the respective sharpnesses of the crest and trough for said cutting edge pattern.

27. The razor blade of claim 12, wherein each cutting edge pattern is provided with a plurality of micro-patterns.

28. The razor blade of claim 12, wherein the cutting edge is single-faceted.

29. The razor blade of claim 12, wherein the cutting edge is double-faceted.

30. A razor blade made in accordance with the method of claim 1.
